(19) United States
(12) Patent Application Publication
(10) Pub. No.: US 2010/0115533 A1
(43) Pub. Date: May 6, 2010

(54) Request content extraction method and apparatus

(75) Inventors: Takeshi Miyamae, Kawasaki (JP); Yoshitake Shinkai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/591,947

(22) Filed: Dec. 4, 2009

Related U.S. Application Data
(63) Continuation of application No. PCT/JP07/61316, filed on Jun. 4, 2007.

(51) Int. Cl. G06F 9/44

(52) U.S. Cl. 719/321

(57) ABSTRACT

A filter object is set to combine with a driver causing a device to operate by calling entry functions from a kernel. A second function, via which the driver notifies to a first function of the kernel an entry point, a collection of memory addresses of the entry functions, and an entry point of the filter object, are defined in advance for the filter object. The filter object is caused to extract the entry point of the driver, if, upon installation of the driver, the driver is caused to call the second function defined in advance for the filter object; and to set the entry point of the filter object as an argument and call the first function of the kernel, to extract a content of a request from an application to the device, after the entry point is extracted.

### CROSS-REFERENCE TO RELATED APPLICATION

This application is a continuation of International Application No. PCT/JP2007/061316, filed on Jun. 4, 2007, the entire contents of which are incorporated herein by reference.

### FIELD

The embodiment discussed herein is directed to a program, a method, and an apparatus for request content extraction.

### BACKGROUND

A method of performing operational control of a device (hereinafter, “target device”) like a hard disk via a kernel has been known conventionally. Specifically, by causing to call an entry function from the kernel, the device driver notifies a request from an application to the target device, and according to the content of the notified request, the target device performs operations such as read/write operations. Thus, as illustrated in FIG. 4A, the content of a request is notified to the target device via a route through the requesting application, an operating system (OS) as the kernel, and the device driver. The entry function is a registered function of the device driver to the kernel.

There is a demand for a technology (filtering technology) of extracting, the contents of requests from a requesting application to a target device without modifying a device driver. By using the filtering technology to extract and comprehend the contents of requests like read/write requests to a target device, it is possible to extract update requests to the target device as appropriate to perform smooth transition of data to a new device even while, for example, carrying on other operations. As illustrated in FIG. 4B, in a configuration in which a logical volume manager that manages logical volumes is disposed between an OS as a kernel and a device driver, by using a filtering technology to comprehend the content of a request from the logical volume manager, it is possible to achieve smooth transition of the logical volume. FIGS. 4A to 4C are schematic diagrams for explaining the conventional technology.

One filtering technology uses a pseudo device independent of a target device. Specifically, by setting a pseudo device in an OS, and causing a request notified to the target device to be performed with respect to the pseudo device, the content of the request is extracted. The pseudo device notifies the content of the request to the target device and the target device performs the conventional operations. For example, as illustrated in FIG. 4C, if a requestor application recognizes a target device as “device number: 1”, by modifying the settings so that the requestor application recognizes a pseudo device that is “device number: 2”, the content of the request is extracted via the pseudo device.

Japanese Laid-open Patent Publication No. 2000-99364 discloses a technology of linking a debugging device driver that detects and corrects bugs in a device driver (i.e., performs debugging) to a device driver to be debugged (debugged target device driver) to extract output data for debugging without changing the internal code of the debugged target device driver.

Japanese Laid-open Patent Publication No. 2006-139465 discloses a technology of executing a program code without modification by statically linking in advance a library function used upon execution of a program code created by a user to a dummy function of the same name to not allow reference to a runtime library of a system that experimentally executes the program code to prevent serious failure to the system.

However, in the abovementioned conventional filtering technology, it is not possible to extract the content of a request easily because the filtering method has to be designed according to the specification of the requestor application. That is, it is not possible to easily extract the content of a request because the filtering method has to be designed after a method of identifying by the requestor application a device is determined according to the specification of the requestor application.

Moreover, if the specification of the source code of the requestor application has not been made completely public, it becomes difficult to determine the method of identifying the target device. Therefore, it is not possible to change recognition settings of the requestor application from the target device to the pseudo device and thus to extract the content of a request easily.

Furthermore, even if a method of identifying a device is determined, depending on the determined method, it may be difficult to change recognition of a target device at a requestor application to a pseudo device. Therefore, it is not possible to extract the content of a request easily.

### SUMMARY

According to an aspect of an embodiment of the invention, a computer readable storage medium has stored therein a request content extracting program causing a computer to execute a request content extracting method. This method causes a filter object to extract a content of a request made from an application with respect to a target device. The filter object has been set to combine with a device driver that is software causing the target device to operate by calling entry functions from a kernel. A second entry point notification function via which the device driver notifies to a first entry point notification function of the kernel an entry point that is a collection of memory addresses of the entry functions, and an entry point of the filter object, both have been defined in advance for the filter object. The method includes: causing the filter object to extract the entry point of the device driver, if, upon installation of the device driver, the device driver is caused to call the second entry point notification function that has been defined in advance for the filter object; and causing the filter object to set the entry point of the filter object as an argument and call the first entry point notification function of the kernel, to extract the content of the request, after the entry point is extracted.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIGS. 1A to 1D are schematic diagrams for explaining an outline and features of a control apparatus according to a first embodiment;

FIG. 2 is a block diagram of a configuration of the control apparatus according to the first embodiment;

FIG. 3 is a flowchart for explaining operations performed in the control apparatus according to the first embodiment; and

FIGS. 4A to 4C are schematic diagrams for explaining the conventional technology.

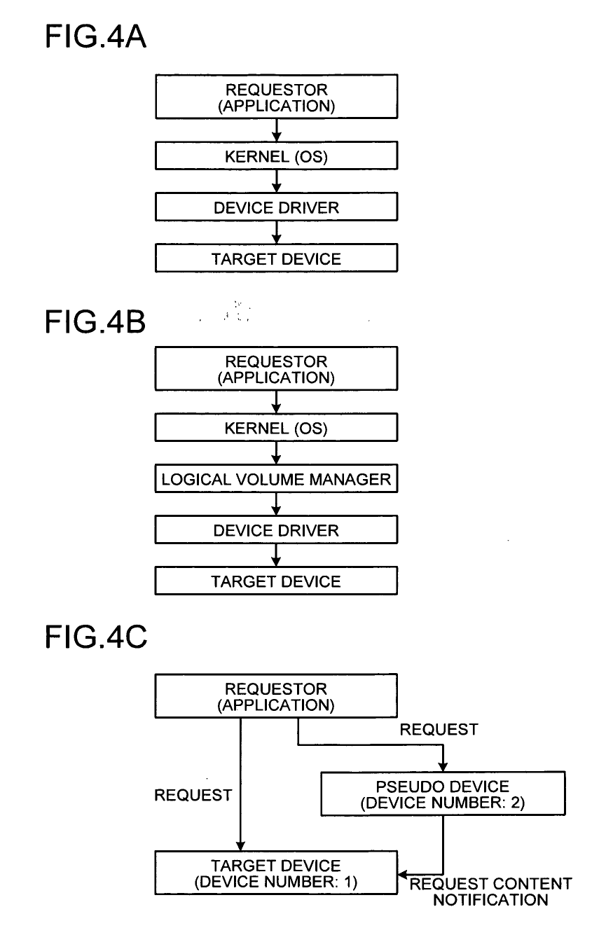

### DESCRIPTION OF EMBODIMENT(S)

Preferred embodiments of the present invention will be explained with reference to accompanying drawings. In the following description, a case of applying the present invention to a control apparatus is explained as an embodiment. An outline and features of a control apparatus according to a first embodiment, a configuration of and a sequence of operations performed in the control apparatus according to the first embodiment, and effects of the first embodiment will be explained below.

### [a] First Embodiment

### Explanation of Terms

Firstly, the key terms used in the following embodiment are explained. The term “device driver” used in the following embodiment represents software that makes a target device such as a hard disk or the like operate by causing a call of an “entry function” from a “kernel”. The term “kernel” represents software that implements basic operations of an operating system (OS) like “monitoring applications and peripheral devices” and “managing resources such as a hard disk and a memory”.

The term “entry function” represents a registered function of a “device driver” to a “kernel” and encompasses the term “entry point notification function”. The term “entry point” represents a collection of memory addresses of “entry functions”. Specifically, an “entry point” is a structure of collected memory address of a plurality of “entry functions” such as read functions and write functions. The term “entry point notification function” represents a function that a “device driver” calls from the “kernel” upon installation of the “device driver”. The calling of the “entry point notification function” allows the OS to obtain the “entry point” of the corresponding “device driver”. For example, in Solaris (registered trademark), which is an OS provided by Sun Microsystems, Inc., the “mod_install” is the “entry point notification function”.

### Outline and Features of the Control Apparatus According to the First Embodiment

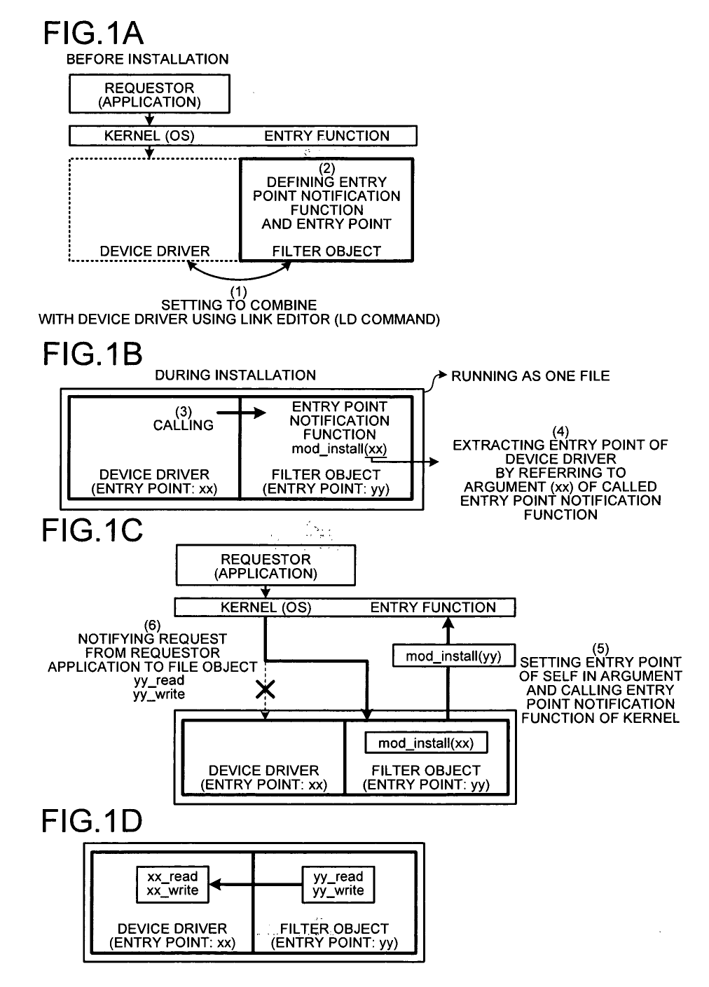

Given below is the description of the main features of the control apparatus according to the first embodiment with reference to FIGS. 1A to 1D. FIGS. 1A to 1D are schematic diagrams for explaining an outline and features of the control apparatus according to the first embodiment.

In the control apparatus according to the first embodiment, a filter object is set to combine with a device driver, and arranged with an entry point notification function and an entry point thereof defined in advance. The filter object extracts the content of a request made from an application with respect to a target device. Before the device driver is installed (or after the device driver is uninstalled), an administrator of the control apparatus according to the first embodiment sets the filter object to combine with that device driver using a link editor (e.g., in the case of Solaris (registered trademark), using the “ld command”) (see (1) in FIG. 1A), and with respect to the filter object, the entry point notification function and the entry point are defined in advance (see (2) in FIG. 1A).

Thus, in the control apparatus according to the first embodiment, by using the filter object set as described above, the content of the request (e.g., read/write requests or the like) from a requestor application to a target device via a route through the kernel (OS) and the device driver is extracted as illustrated in FIG. 1A.

The main feature of the present invention is in that it becomes possible to extract the content of a request easily. Following is a brief description regarding that main feature. When a device driver calls, at the time of being installed, the entry point notification function that has been defined in advance in the filter object, which is arranged in the control apparatus according to the first embodiment, the filter object extracts the entry point of that device driver.

That is, as illustrated in FIG. 1B, at the time of installing a device driver, the device driver combines with the filter object that has been set in the control apparatus according to the first embodiment to run as a single file (software). Then, the device driver calls the entry point notification function of the filter object (see (3) in FIG. 1B) and not the entry point notification function of the kernel (OS) (in the case of Solaris (registered trademark), the “mod_install( )”). Consequently, the filter object extracts the entry point of the device driver by referring to the argument of the entry point notification function that has been called. For example, in the case of Solaris (registered trademark), the filter object refers to the argument “address within brackets of ‘mod_install(xx)’” and extracts the entry point (xx) of the device driver (see (4) in FIG. 1B).

After extracting the entry point, the filter object in the control apparatus according to the first embodiment sets the entry point of the filter object as the argument, calls the entry point notification function of the kernel, and extracts the content of a request. For example, after extracting the entry point (xx) of the device driver, the filter object sets its own entry point (yy) as the argument and calls an entry point notification function “mod_install(yy)” of the kernel (OS) (see (5) in FIG. 1C). Consequently, the kernel (OS) notifies the content of a request from a requestor application to the filter object and not to the device driver. For example, as read/write requests, “yy_read” and “yy_write” are notified to the filter object (see (6) in FIG. 1C), and the filter object extracts the contents of the requests from the device driver to the target device.

Upon extracting the content of the requests, the filter object set in the control apparatus according to the first embodiment sets as-is the argument that has been passed to its own entry point and notifies the content of each request to the device driver by calling the entry functions of the extracted entry point of the device driver. That is, as illustrated in FIG. 1D, the filter object notifies the content of each request from the requestor application to the device driver by calling, from the kernel (OS), the entry functions (xx_read and xx_write) of the extracted entry point of the device driver in individual functions (yy_read and yy_write) of the group of entry functions set by itself.

If functions having the same names as the entry functions called from the kernel remain defined in the filter object, a symbol collision error occurs upon incorporation of the device driver into the kernel. Thus, after the abovementioned processing is complete, the scope of the same functions is changed to a local attribute using a symbol attribute definition file of the link editor to prevent them from being executed.

As such, by setting the filter object in the control apparatus according to the first embodiment, it is possible to extract the content of a request from a requestor application independently of the specification of the requestor application. Thus, as described above as the main feature, it is possible to extract the content of the request easily.

### Configuration of the Control Apparatus According to the First Embodiment

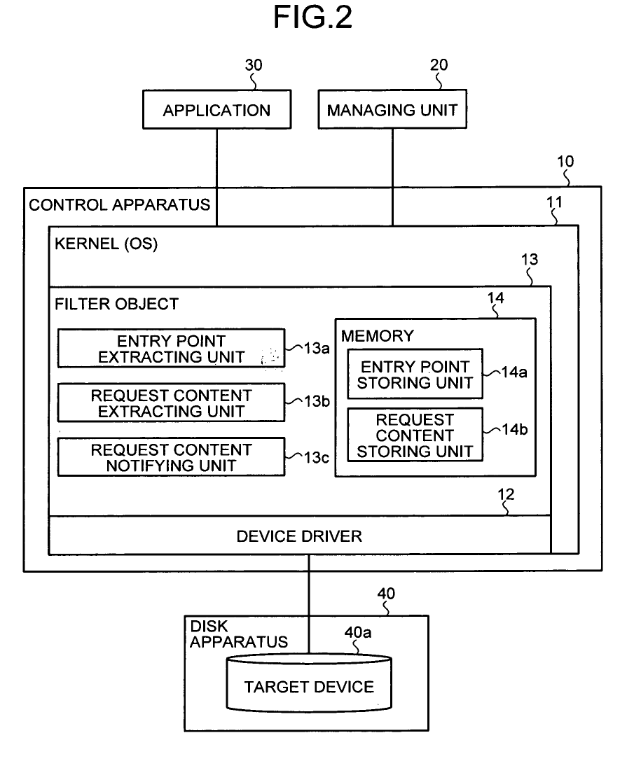

Given below is the description of the control apparatus according to the, first embodiment with reference to FIG. 2. FIG. 2 is a block diagram of a configuration of the control apparatus according to the first embodiment.

As illustrated in FIG. 2, a control apparatus 10 according to the first embodiment includes a kernel 11, a device driver 12, and a filter object 13. Moreover, the control apparatus is connected to a managing unit 20, an application 30, and a disk apparatus 40 that includes a target device 40a.

The managing unit 20 receives and manages an input from the administrator of the control apparatus 10 of the settings related to installation of the filter object 13 described later and also accepts and manages the installation of the device driver 12 described later.

The target device 40a in the disk apparatus 40 receives a request from the application 30 via the device driver 12 described later, and performs, for example, read/write operations. Specifically, the target device 40a corresponds to a hard disk or the like.

The kernel (OS) 11 is software that implements the basic operations of the OS. For example, the kernel (OS) 11 notifies the content of a request from the application 30 to the target device 40a via the device driver 12, which is software for operating the target device.

The filter object 13 is installed in the control apparatus 10 according to the settings input through the managing unit 20. The filter object 13 is set to combine with the device driver 13, and an entry point notification function and an entry point thereof are defined therein in advance. The filter object 13 includes an entry point extracting unit 13a, a request content extracting unit 13b, a request content notifying unit 13c, and a memory 14 as illustrated in FIG. 2, which are closely related to the present invention. The memory 14 includes an entry point storing unit 14a and a request content storing unit 14b as illustrated in FIG. 2. The entry point storing unit 14a stores the entry point of the filter object 13 as well as the entry point extracted by the entry point extracting unit 13a. The request content storing unit 14b stores the content of a request from the application 30 to the target device 40a extracted by the request content extracting unit 13b. Herein, the entry point extracting unit 13a corresponds to the entry point extraction described in the claims, the request content extracting unit 13b corresponds to the request content extraction described in the claims, and the request content notifying unit 13c corresponds to the request content notification described in the claims.

When the device driver 12 calls, at the time of being installed, the entry point notification function that has been defined in advance in the filter object 13, the entry point extracting unit 13a extracts the entry point of the device driver 12 and stores the result in the entry point storing unit 14a. As illustrated in FIG. 2, at the time of being installed, the device driver 12 combines with the filter object 13 that has already been installed in the control apparatus 10 to run as a single file. When the device driver 12 calls the entry point notification function that has been defined in advance in the filter object 13, the entry point extracting unit 13a extracts the entry point of the device driver 12 by referring to the argument of the entry point notification function that has been called. For example, in the case of Solaris (registered trademark), the filter object 13 refers to the argument “address within brackets of mod_install(xx)” and extracts the entry point (xx) of the device driver (see (4) in FIG. 1B).

After the entry point of the device driver 12 is stored in the entry point storing unit 14a, the request content extracting unit 13b sets the entry point of the filter object 13, which has been stored in the entry point storing unit 14a, as the argument, calls the entry point notification function of the kernel (OS) 11, extracts the content of a request, and stores the result in the request content storing unit 14b. For example, after extracting the entry point (xx) of the device driver 12, the request content extracting unit 13b sets an entry point (yy) of the filter object 13 as the argument and calls an entry point notification function “mod_install(yy)” of the kernel (OS) 11 (see (5) in FIG. 1C). Consequently, the kernel (OS) 11 notifies the content of a request from the requestor application 30 (e.g., as read/write requests, “yy_read” and “yy_write”) to the filter object 13 (see (6) in FIG. 1C), and the request content extracting unit 13b extracts the content of the request to the target device 40a from the device driver 12.

The request content notifying unit 13c sets as-is the argument that has been passed to the entry point of the filter object 13 and notifies the content of each request to the device driver 12 by calling the entry functions of the extracted entry point of the device driver 12. That is, as illustrated in FIG. 1D, the request content notifying unit 13c notifies the content of each request from the requestor application to the device driver 12 by calling, from the kernel (OS) 11, the entry functions (xx_read and xx_write) of the extracted entry point of the device driver 12 in individual functions (yy_read and yy_write) of the group of entry functions set by the filter object 13.

### Sequence of Operations in the Control Apparatus According to the First Embodiment

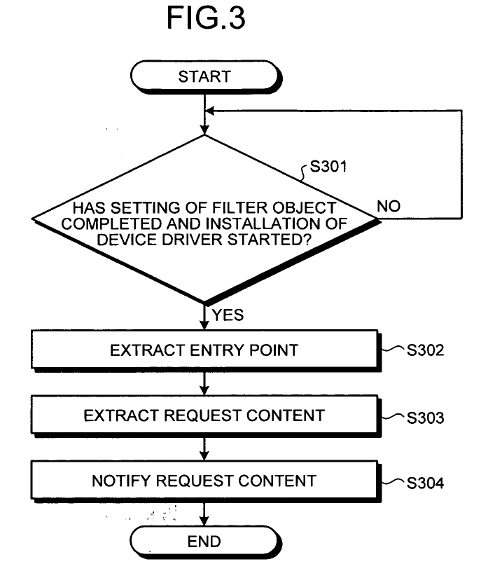

Given below is the description of operations performed in the control apparatus 10 according to the first embodiment with reference to FIG. 3. FIG. 3 is a flowchart for explaining operations performed in the control apparatus 10 according to the first embodiment.

As illustrated in FIG. 3, in the control apparatus 10 according to the first embodiment, when the setting of the filter object 13 is complete and when the installation of the device driver 12 starts (Yes at Step S301), the entry point extracting unit 13a extracts the entry point of the device driver 12 (Step S302).

More particularly, once the setting related to the filter object 13, “combine with the device driver 12, and define the entry point notification function and the entry point” is input with respect to the managing unit 20, the filter object 13 is installed in the control apparatus 10. Subsequently, with the start of the installation of the device driver 12, the device driver 12 is combined with the filter object 13. When the device driver 12 calls the entry point notification function that has been defined in advance in the filter object 13, the entry point extracting unit 13a extracts the entry point of the device driver 12 by referring to the argument of the entry point notification function that has been called.

Then, the request content extracting unit 13b sets the entry point of the filter object 13, which has been stored in the entry point storing unit 14a, as the argument; calls the entry point notification function of the kernel (OS) 11, and extracts the content of the request (Step S303). For example, the request content extracting unit 13b sets an entry point (yy) of the filter object 13 as the argument and calls an entry point notification function “mod_install(yy)” of the kernel (OS) 11. Consequently, the content of the request from the application 30 to the target device 40a via the device driver 12 is extracted.

Subsequently, the request content notifying unit 13c sets as-is the argument that has been passed to the entry point of the filter object 13 and notifies the content of each request to the device driver 12 by calling the entry functions of the extracted entry point of the device driver 12 (Step S304). That is, as illustrated in FIG. 1D, the request content notifying unit 13c notifies the content of each request from the requestor application to the device driver 12 by calling, from the kernel (OS) 11, the entry functions (xx_read and xx_write) of the extracted entry point of the device driver 12 in individual functions (yy_read and yy_write) of the group of entry functions set by the filter object 13.

### Effect of the First Embodiment

As described above, according to the first embodiment, when the device driver 12 calls, at the time of being installed, the entry point notification function that has been defined in advance in the filter object 13, the filter object 13 extracts the entry point of the device driver 12. After the entry point is extracted, the filter object 13 sets its own entry point as the argument, calls the entry point notification function of the kernel (OS) 11, and extracts the content of the request. As a result, it becomes possible to extract the content of the request from the requestor application 30 independently of the specification of the requestor application 30 and thus to extract the content of the request easily. That is, since it is possible to remove the work of designing a filtering method such as modifying the device driver 12 or changing device recognition of the requestor application 30, for each specification of the requestor application 30, and thus to easily extract the content of the request.

Moreover, according to the first embodiment, upon extracting the content of the request, the filter object 13 sets as-is the argument that has been passed to the entry point thereof and notifies the content of each request to the device driver 12 by calling the entry functions of the extracted entry point of the device driver 12. As a result, the device driver 12 is able to control the target device 40a identically to the case without the filter object 13. Therefore, it becomes possible to provide a high-value-added device driver that enables smooth transition of data to a new device even while, for example, carrying on other operations.

All or a part of the processes explained in the first embodiment as being performed automatically may be performed manually (e.g., instead of automatically notifying the extracted content of a request to the device driver 12, the administrator of the control apparatus 10 may refer to the content of the request and then notify the device driver 12). Similarly, all or a part of the processes explained as being performed manually may be performed automatically by known methods (e.g., the setting of the filter object 13 may be performed automatically). The processing procedures, specific terms, various data, and information including parameters described in the embodiment or illustrated in the drawings may be updated unless otherwise specified.

Moreover, the structural elements of the device are illustrated functionally and conceptionally in the drawings, and may not be physically configured as illustrated. That is, specific modes of distribution or integration of each processing unit and each storing unit (e.g., the embodiment in FIG. 2) are not limited to those illustrated in the drawings. For example, the request content extracting unit 13b and the request content notifying unit 13c may be integrated together. All or a part of the units may be separated or integrated either functionally or physically in any units based on various types of loads or use conditions. Furthermore, all or a part of the process functions performed by each device may be realized by a CPU or computer programs that are analyzed and executed by the CPU, or realized as hardware by wired logic.

Meanwhile, the request content extracting program described in the present embodiment may be distributed over a network such as the Internet. Alternatively, the request content extracting program may be recorded in a computer-readable recording medium such as a hard disk, a flexible disk (FD), a compact disk read only memory (CD-ROM), a magneto-optic disk (MO), or a digital versatile disk (DVD) to be read out and executed by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer readable storage medium having stored therein a request content extracting program causing a computer to execute a request content extracting method that causes a filter object to extract a content of a request made from an application with respect to a target device, the filter object having been set to combine with a device driver that is software causing the target device to operate by calling entry functions from a kernel, a second entry point notification function via which the device driver notifies to a first entry point notification function of the kernel an entry point that is a collection of memory addresses of the entry functions, and an entry point of the filter object, both having been defined in advance for the filter object, the request content extracting method comprising:
causing the filter object to extract the entry point of the device driver, if, upon installation of the device driver, the device driver is caused to call the second entry point notification function that has been defined in advance for the filter object; and
causing the filter object to set the entry point of the filter object as an argument and call the first entry point notification function of the kernel, to extract the content of the request, after the entry point is extracted.

2. The computer readable storage medium according to claim 1, causing the computer to execute the request content extracting method further comprising:
causing the filter object to notify each of the content of the request to the device driver by causing the filter object to set as-is an argument that has been passed to the entry point of the filter object to call entry functions of the extracted entry point of the device driver when the filter object has been caused to extract the content of the request.

3. A request content extracting method that causes a filter object to extract to a computer a content of a request made from an application with respect to a target device, the filter object having been set to combine with a device driver that is software causing the target device to operate by calling entry functions from a kernel, a second entry point notification function via which the device driver notifies to a first entry point notification function of the kernel an entry point that is a collection of memory addresses of the entry functions, and an entry point of the filter object, both having been defined in advance for the filter object, the request content extracting method comprising:
causing the filter object to extract the entry point of the device driver, if, upon installation of the device driver, the device driver is caused to call the second entry point notification function that has been defined in advance for the filter object; and
causing the filter object to set the entry point of the filter object as an argument and call the first entry point notification function of the kernel, to extract the content of the request, after the entry point is extracted.

4. The request content extracting method according to claim 3, further comprising:
causing the filter object to notify each of the content of the request to the device driver by causing the filter object to set as-is an argument that has been passed to the entry point of the filter object to call entry functions of the extracted entry point of the device driver when the filter object has been caused to extract the content of the request.

5. A request content extracting apparatus that causes a filter object to extract a content of a request made from an application with respect to a target device, the filter object having been set to combine with a device driver that is software causing the target device to operate by calling entry functions from a kernel, a second entry point notification function via which the device driver notifies to a first entry point notification function of the kernel an entry point that is a collection of memory addresses of the entry functions, and an entry point of the filter object, both having been defined in advance for the filter object, the request content extracting apparatus comprising:
an entry point extracting unit that causes the filter object to extract the entry point of the device driver, if, upon installation of the device driver, the device driver is caused to call the second entry point notification function that has been defined in advance for the filter object; and
a request content extracting unit that causes the filter object to set the entry point of the filter object as an argument and call the first entry point notification function of the kernel, to extract the content of the request, after the entry point is extracted by the entry point extracting unit.

6. The request content extracting apparatus according to claim 5, further comprising:
a request content notifying unit that causes the filter object to notify each of the content of the request to the device driver by causing the filter object to set as-is an argument that has been passed to the entry point of the filter object to call entry functions of the entry point of the device driver extracted by the entry point extracting unit, when the filter object has been caused by the request content extracting unit to extract the content of the request.
